(19) United States
(12) Patent Application Publication
(10) Pub. No.: US 2006/0219723 A1
(43) Pub. Date: Oct. 5, 2006

(54) Thermal insulation and shock absorbing container using air chambers

(76) Inventor: I-Sheng Wang, Torrance, CA (US)

Correspondence Address: LAW OFFICES OF J.F. LEE, 17800 CASTLETON STREET, SUITE 383, CITY OF INDUSTRY, CA, 91748, US

(21) Appl. No.: 10/907,478

(22) Filed: Apr. 1, 2005

(51) Int. Cl. A47J 41/00

(52) U.S. Cl. 220/592.27

(57) ABSTRACT

Thermal insulation and shock absorbing containers using inflatable/deflatable air chambers are presented herein. When containers are not in use, all air chambers are deflated, resulting in substantially reduced volume of containers, easy for transportation and storage. A ring of round-about zipper along the outside of container sidewall further helps to maintain the tightly collapsed configuration of containers, making it easier to handle for transportation or storage purposes.

### FIELD AND BACKGROUND OF THE INVENTION

The present invention relates generally to design and construction of thermal insulation and shock absorbing containers utilizing a plurality of inflatable/deflatable air chambers. Present invention also features a round-about zipper to better facilitate collapsible construction and helps to further reduce the storage volume of the container when not in use.

Present invention aims to solve at least three industry problems:
(1) increase the efficiency of transporting thermal insulation and shock absorbing containers utilizing the existence of inflatable/deflatable air chambers;
(2) reduce the production costs by not using foam as the insulation and shock absorbing properties agent; and,
(3) reduce the storage volume of not-in-use containers.

### OBJECTS AND SUMMARY OF THE INVENTION

Most thermal insulation bags or containers have padded sidewalls, or rigid sidewalls, including the top cover and bottom. These padded layers and the rigid sidewalls both contain some amount of air within them. It's generally known that it's the air that creates the thermal insulation effect. The extent and effectiveness of thermal insulation, of course, depends on the thickness of the layers, to a great extent.

In the traditional way of creating the padded layers, fillings, made of light sponge-like substance or synthetic PU or other materials, are fitted into the padded space, creating the insulation layer, for thermal insulation purpose. Furthermore, due to the nature of the fluffiness of air and/or foam, shock absorption is also achieved.

Similar construction of padded sidewall can also be found on containers to produce shock-absorbing effect, protecting objects, such as computer hard drives or DVD drives, that are susceptible to hard impact and vibrations.

Due to the use of such padded material, not many such containers can be packed together in a carton, either for storage purpose or for transportation purpose. The reason is obvious. The rigid walls or the fillings in the padded space take up physical volume that can only be squeezed to a certain extent.

Present invention utilizes air chambers that allow the creation of an air-thermal layer, or a shock-absorbing layer on a need-to-use basis. Therefore, when the containers or bags are not in use, no air exists in the air chambers, enabling more units of containers to be packed together, for better storage and transportation purposes.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows the profile view of a container of present invention, having air chambers located on the inside of sidewall, base and cover. A valve connected to one of the air chambers is shown. A valve with extension tube is also shown.

FIG. 2 shows a second embodiment of present invention by having a layer of thermal air chambers separated from the container's body shell.

FIG. 3 shows a third embodiment of present invention wherein container's body shell has some pockets to receive removable air chamber inserts.

FIG. 4 shows the use of a ring of zipper of present invention to tightly collapse a soft container by zipping the top and bottom together.

### DETAILED DESCRIPTION OF THE PREFERRED EMBODIMENT

Thermal insulation containers are usually made from a variety of materials, including, but not limited to, polyurethane (PU), polyethylene (PE), etc. These materials allow containers/bags to be soft, pliable and, generally, durable.

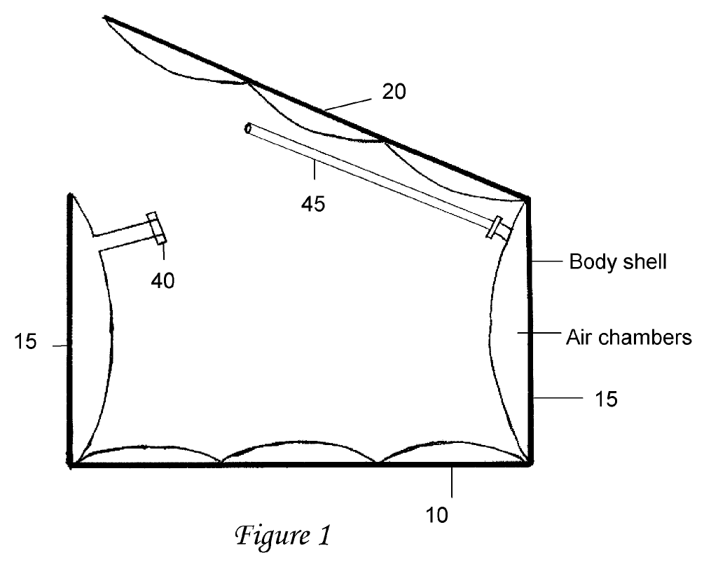

Containers made from these materials generally have a base 10, a cover 20 and an all-around sidewall 15 connecting said base 10 and cover 20, as shown in FIG. 1.

Body shell is the complete casing of the container. Base 10, cover 20 and sidewall 15 are all part of body shell.

Depending on the design, the sidewall 15 can be made into different shapes, when looked down from a bird's-eye view, such as rectangle, square, round, oval or other polygon shapes. All the shapes can benefit from present invention.

FIG. 1 shows that, on the inside surface of said base 10, cover 20 and sidewall 15, multiple air chambers can be built in, along with one or more valve 40, so that when air is pumped into (can be as simple as by human breathing into) air chambers, a layer of air thermal space is created, to produce the desired insulation effect, as well as the shock absorbing function.

When the container is not in use, air chambers are deflated, causing the container to take up little space, reducing per unit volume of the container and thus is desirable for transportation and storage purpose.

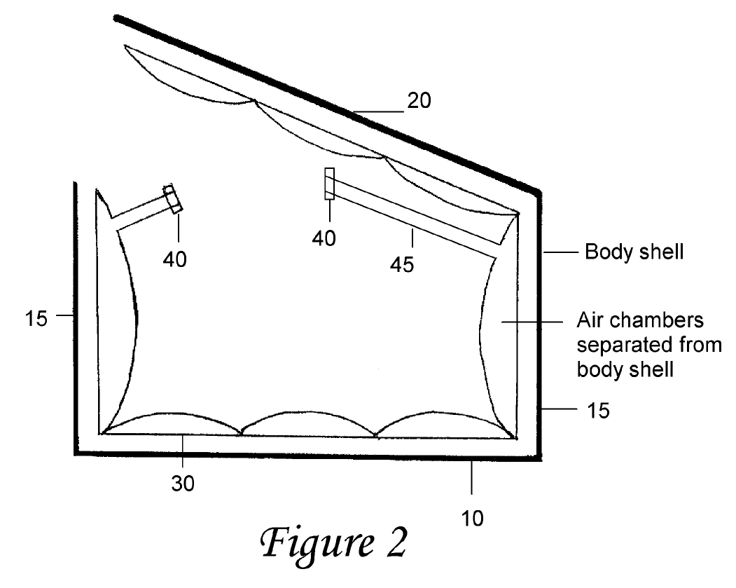

Depending on implementation, tubes 45 may be added, as shown in FIG. 1, to said valve(s) 40 allowing flexibility in the manner air is pumped into and out of said air chambers. Also depending on implementation, tubes 45 may be added as an extension of the valve 40 to the chambers, as shown in FIG. 2.

Latch devices can be added to the cover, allowing the cover to be securely closed. This can be done by using a flap having Velcro, or a ring of zipper along the rim of cover and corresponding rim on top of sidewall. These latching devices are generally known mechanical structures and need no disclosure herein; nor is present invention claiming any right on the latching devices, except as they specifically appeared in the combination of the disclosed invention herein.

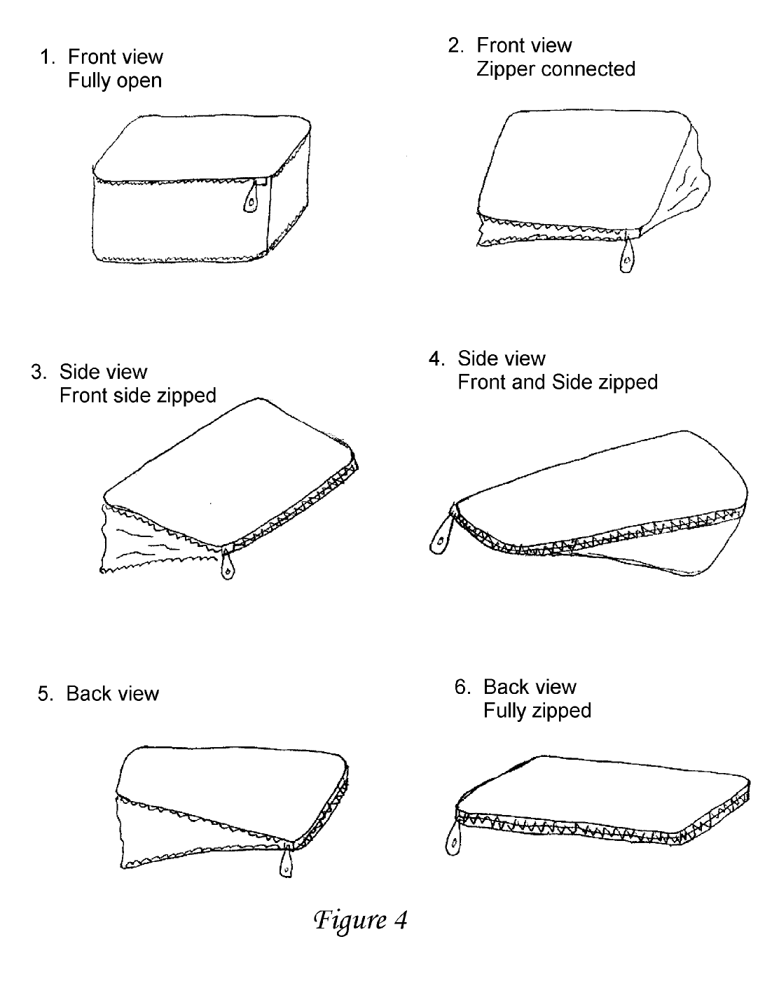

FIG. 4 shows a ring of zipper built along the outside portion of sidewall 15. By zipping close the zipper (when the air chambers are deflated), containers of present invention are tightly collapsed and made even easier for packing and storing away.

FIG. 2 shows a second embodiment of present invention, wherein air chambers are constructed on a layer 30 that is separated from the body shell of the container. The shape and size of the air chamber layer 30 is made to be fitted snugly to the inside of the container body shell. All other additional features, such as extension tube 45, can similarly be affixed to air chambers in present configuration.

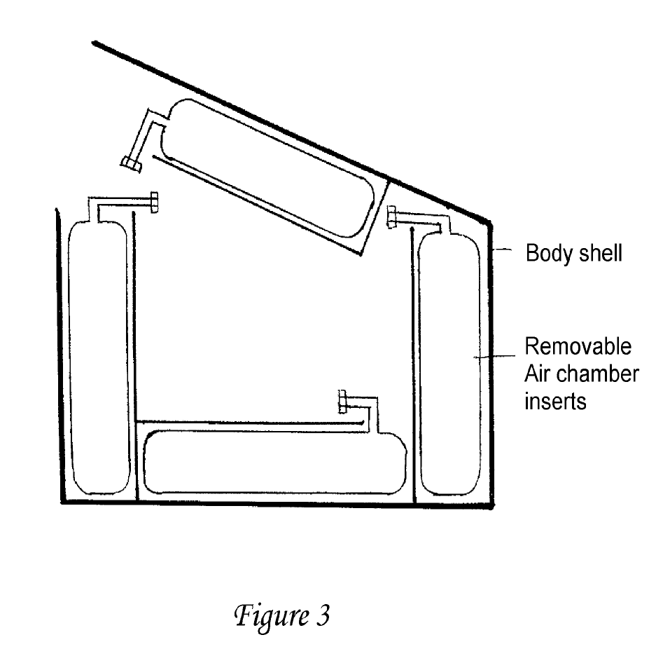

FIG. 3 shows a third embodiment of present invention, wherein a plurality of pockets exist on the inside surface of the container body shell. Removable air chamber inserts can be placed inside respective pockets to produce the desired thermal insulation and/or shock absorbing effects.

What is claimed is:

1. A thermal insulation and shock absorbing container, comprising:
a. A base;
b. An all-around sidewall connected to said base and extending upwardly;
c. A cover connected to a portion the top of said sidewall;
d. A plurality of air chambers affixed to the inner side of said cover, sidewall and base;
e. A plurality of valves attached to said air chambers for getting air into and out of said air chambers; and,
f. A ring of zipper construction along the outer side of said sidewall, thereby allowing the top and bottom of sidewall to be collapsibly zipped together.

2. The container of claim 1, wherein a plurality of tubes are removably connected to said valves for ease of pumping air into said air chambers.

3. The container of claim 2, wherein said cover further having sealing mechanism to securely close said cover to said sidewall, thereby creating a closed thermal space inside said container.

4. The container of claim 3, wherein said sealing mechanism is a length of zipper respectively and correspondingly along the connecting rim of cover and top of sidewall.

5. The container of claim 3, wherein said sealing mechanism is a latch to keep said cover together with top of said sidewall.

6. A thermal insulation and shock absorbing container, comprising:
a. A container shell; and,
b. A removable layer of insulation consisting of a plurality of inflatable air chambers, said layer is sized to snugly fit all the inside surface of said container shell.

7. A thermal insulation and shock absorbing container, comprising;
a. A container shall having a plurality of pockets situated on the inside of said container; and,
b. A plurality of removable air chamber inserts sized to fit the inside of said pockets.
